(19) United States
(12) Patent Application Publication
(10) Pub. No.: US 2026/0137031 A1
(43) Pub. Date: May 21, 2026

(54) MOWER YOKE ASSEMBLY

(71) Applicant: Textron Inc., Providence, RI (US)

(72) Inventors: Jamie Mark Clements, Ipswich (GB); Luke John Peter Manning, Suffolk (GB); Robert George Austin Johns, Suffolk (GB)

(73) Assignee: Textron Inc., Providence, RI (US)

(21) Appl. No.: 18/955,345

(22) Filed: Nov. 21, 2024

(51) Int. Cl. A01D 67/00; A01D 34/412; A01D 101/00

(52) U.S. Cl. CPC A01D 67/005; A01D 34/412; A01D 2101/00

(57) ABSTRACT

A mower includes a chassis, a tractive element coupled to the chassis, a deck arm coupled to the chassis, a mower deck, and a yoke assembly. The yoke assembly is coupled between the mower deck and the deck arm. The yoke assembly is configured to provide a first rotation about a first axis, a second rotation about a second axis, and a third rotation about a third axis.

### BACKGROUND

The present application relates a yoke assembly of a vehicle. More specifically, the present application relates to the yoke assembly of a mower.

### SUMMARY

One embodiment relates to a mower. The mower includes a chassis, a tractive element coupled to the chassis, a deck arm coupled to the chassis, a mower deck, and a yoke assembly. The yoke assembly is coupled between the mower deck and the deck arm. The yoke assembly is configured to provide a first rotation about a first axis, a second rotation about a second axis, and a third rotation about a third axis.

Another embodiment relates to a mower assembly. The mower assembly includes a mower deck, a deck arm configured to couple to a chassis, a first bracket coupled to the mower deck, a second bracket coupled to the mower deck, and a yoke assembly coupled to the mower deck. The yoke assembly includes a yoke, a ball joint, and a shaft. The yoke includes a first plate pivotably coupled to the first bracket, a second plate pivotably coupled to the second bracket, and a bar extending between the first plate and the second plate. The ball joint is coupled to the bar. The shaft is pivotably coupled to the deck arm and coupled to the ball joint.

Still another embodiment relates to a mower assembly. The mower assembly includes a mower deck, a first bracket coupled to the mower deck, a second bracket coupled to the mower deck, and a yoke assembly coupled to the mower deck. The yoke assembly includes a yoke. The yoke includes a first plate pivotably coupled to the first bracket, a second plate pivotably coupled to the second bracket, and a bar extending between the first plate and the second plate. The yoke assembly includes a ball joint coupled to the bar, a housing within which the ball joint is received, a shaft extending from the housing where the shaft is configured to couple to a deck arm of a mower, a bushing disposed along the shaft, and a stop positioned to engage with the bar to at least partially limit movement of the mower deck relative to the deck arm.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a perspective view of a vehicle, according to an exemplary embodiment.

FIG. 1B is a perspective view of a vehicle, according to another exemplary embodiment.

FIG. 2 is a schematic block diagram of the vehicles of FIGS. 1A and 1B, according to an exemplary embodiment.

FIG. 3 is a perspective view of the mower deck of FIG. 1A, according to an exemplary embodiment.

FIG. 4 is a perspective view of the mower deck of FIG. 3, according to an exemplary embodiment.

FIG. 5 is a perspective view of the mower deck of FIG. 3, according to an exemplary embodiment.

FIG. 6 is a perspective view of the mower deck of FIG. 3, according to an exemplary embodiment.

FIG. 7 is a side view of the mower deck of FIG. 3, according to an exemplary embodiment.

FIG. 8 is a perspective view of the mower deck of FIG. 1A, according to an exemplary embodiment.

FIG. 9 is a perspective view of the mower deck of FIG. 1A, according to an exemplary embodiment.

FIG. 10 is a perspective view of a yoke assembly of the mower deck of FIG. 8, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

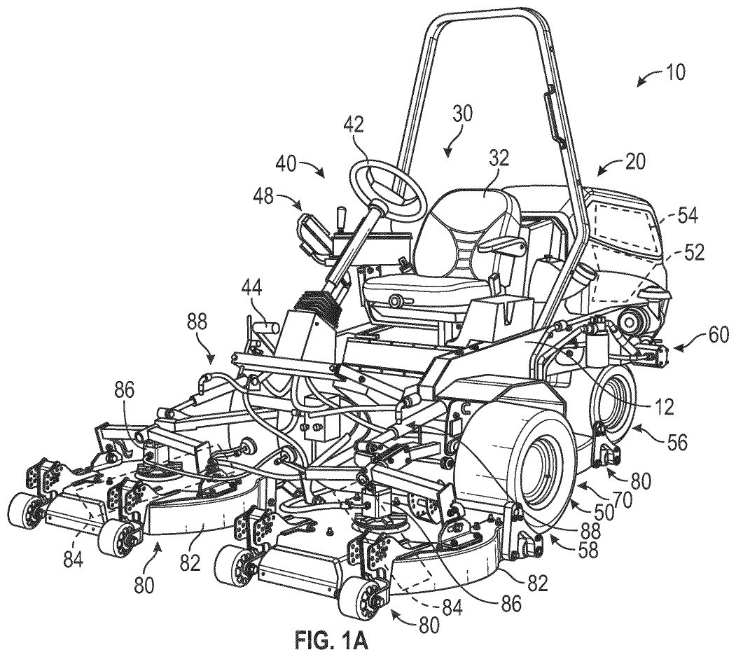

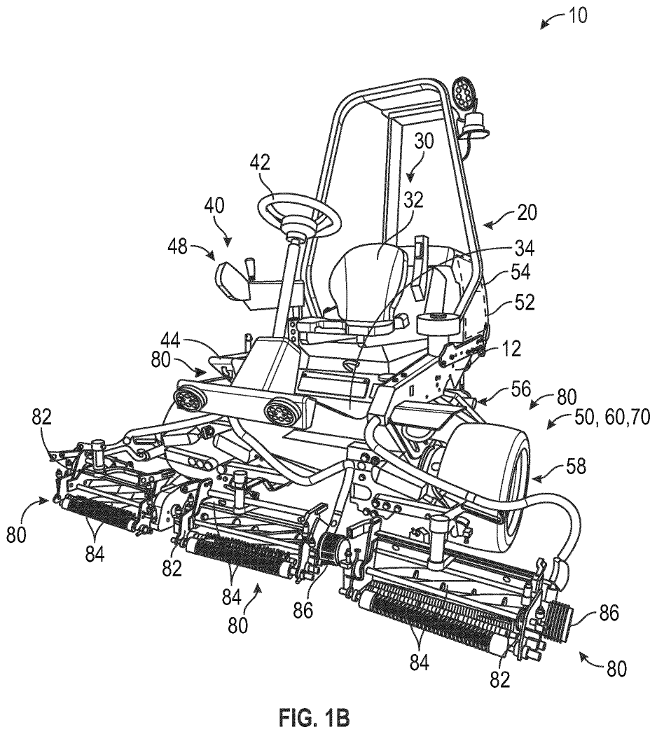

As shown in FIGS. 1A-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIGS. 1A and 1B, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIGS. 1A and 1B, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIGS. 1A and 1B, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

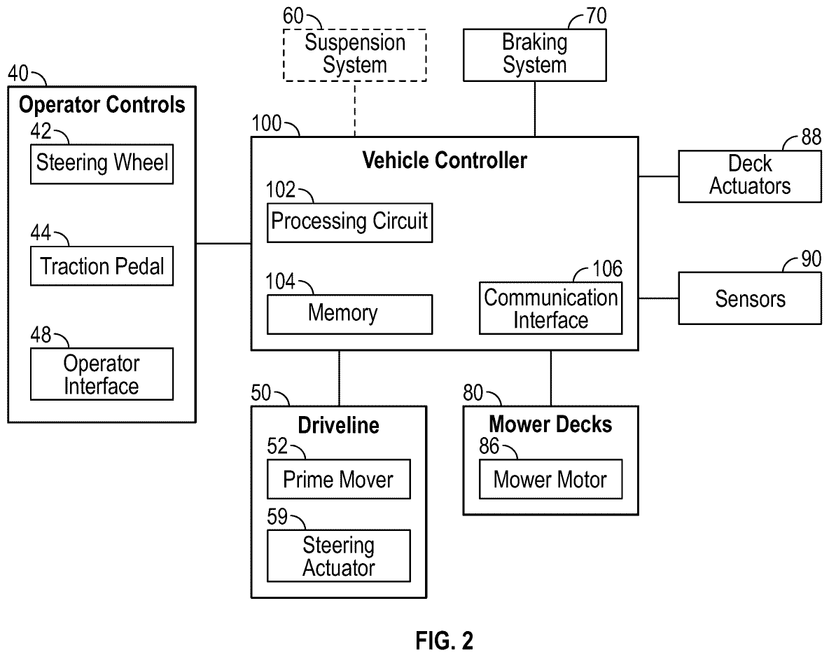

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1A, 1B, and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1A, 1B, and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIGS. 1A and 1B, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIGS. 1A and 1B, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the vehicle of FIG. 1A illustrates a vehicle 10 in which the mower decks 80 each include a cutting element 84 configured as a blade that rotates about a substantially vertical axis. FIG. 1B illustrates an alternative configuration in which the cutting elements 84 are configured as reels that each rotate about a substantially horizontal axis. Except as otherwise specified, the vehicle 10 of FIG. 1A may be substantially similar to the vehicle 10 of FIG. 1B. Accordingly, a description of the vehicle 10 of FIG. 1A may apply to the vehicle 10 of FIG. 1B, except as otherwise specified.

Referring to FIGS. 1A and 1B, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 represents a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other of the vehicles 10, user sensors, a user portal, a remote systems, etc.). By way of example, the communication interface 106 may be configured to employ one or more types of wireless communications protocols including Bluetooth, Wi-Fi, radio, cellular, and/or other suitable wireless communications protocols.

### Mower Yoke Assembly

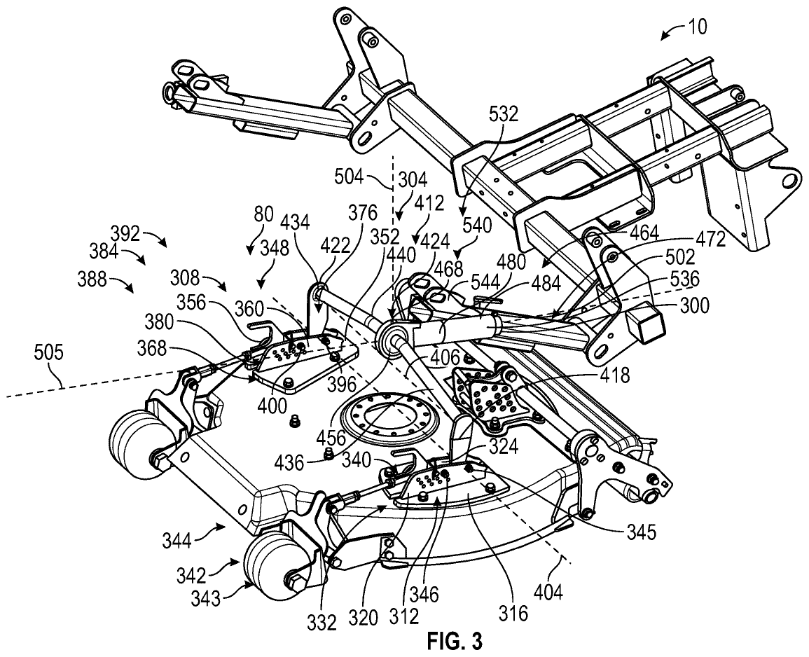

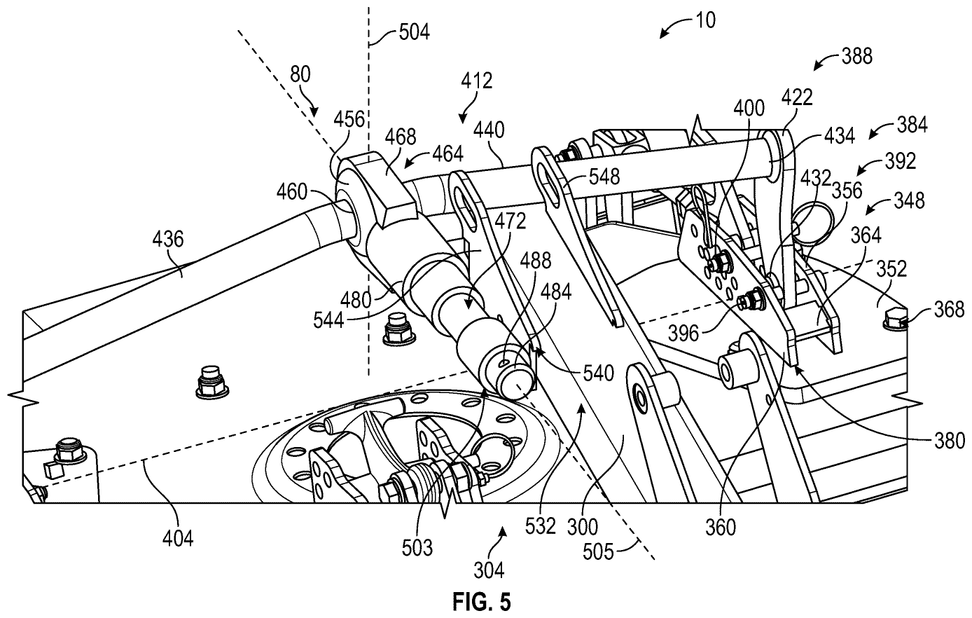

As shown in FIGS. 3-5, the vehicle 10 includes a deck arm, shown as mower arm 300, a yoke assembly 304, and one or more brackets 308. The mower arm 300 couples to the yoke assembly 304, the yoke assembly 304 couples to the brackets 308, and the one or more brackets 308 couple to the mower deck 80. The brackets 308 include a first bracket 312 and a second bracket 348.

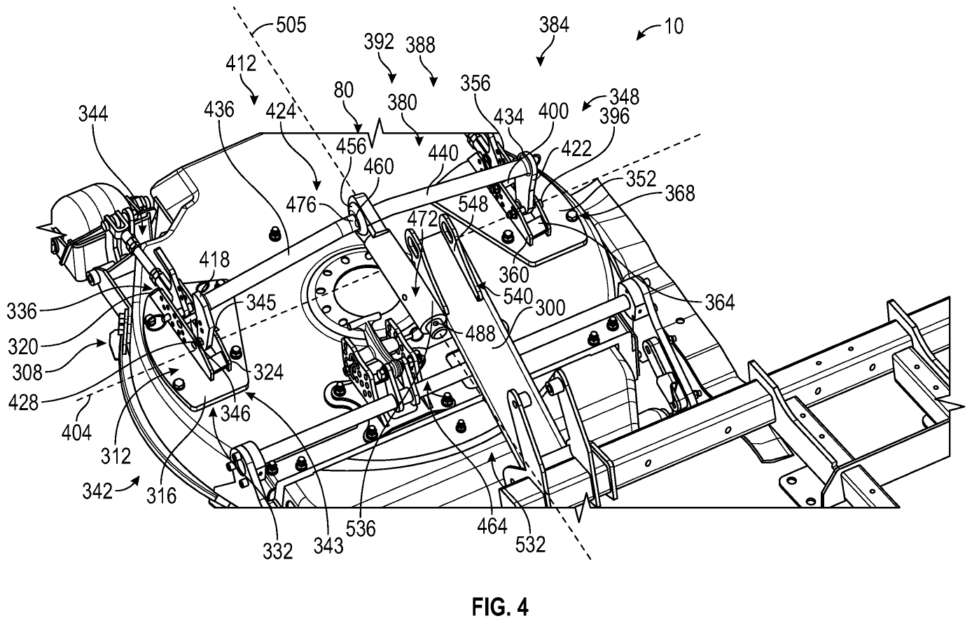

As shown in FIGS. 3 and 4, the first bracket 312 includes a lateral plate, shown as first plate 316, a first longitudinal plate, shown as second plate 320, and a second longitudinal plate, shown as third plate 324, and an extension portion, shown as stop 328. The first plate 316 is substantially parallel to the mower deck 80 and is coupled to the mower deck 80. The first plate 316 includes one or more apertures 332 configured to receive fasteners to couple the first plate 316 to the mower deck 80. The second plate 320 and the third plate 324 each extend from the first plate 316 and are substantially perpendicular to the first plate 316. The second plate 320 is substantially parallel to and spaced from the third plate 324. The second plate 320 defines one or more apertures 336 and the third plate 324 defines one or more apertures 340 configured to receive pins or fasteners. The second plate 320 and the third plate 324 each extend from a first end of the first plate 316 towards a second end of the first plate 316, the first end opposite the second end. The stop 328 extends between the second plate 320 and the third plate 324 and is spaced from the first plate 316. The stop 328 is configured to contact a portion of the yoke assembly 304 and limit rotation of the yoke assembly 304 in a first rotational direction (e.g., toward the mower arm 300, etc.). The stop 328 prevents the yoke assembly 304 from rotating too far, which limits overlap issues (e.g., limits uncut grass, etc.). In some embodiments, the stop 328 extends between the second plate 320, the third plate 324, and the first plate 316.

As shown in FIGS. 3 and 4, the mower deck 80 includes one or more first bracket fasteners 342. The first bracket fasteners 342 include one or more lateral plate fasteners 343 configured to be received within the apertures 332 of the first plate 316 to couple the first plate 316 to the mower deck 80. The first bracket fasteners 342 include one or more longitudinal plate pins 344, including a first pin 345 and a second pin 346. The first pin 345 and the second pin 346 extend between the second plate 320 and the third plate 324. The first pin 345 is located closer to the mower arm 300 than the second pin 346. The first pin 345 is configured to couple to a portion of the yoke assembly 304 and the second pin 346 is configured to contact a portion of the yoke assembly 304 and act as a stop to limit rotation of the yoke assembly 304 in the first rotational direction (e.g., limit rotation away from the mower arm 300, etc.). The second pin 346 prevents the yoke assembly 304 from rotating too far, which limits overlap issues (e.g., limits uncut grass, etc.). The first pin 345 coincides with a first axis 404 and provides the first rotation about the first axis 404 (e.g., the first rotation is provided about the first pin 345, etc.).

As shown in FIGS. 3-5, the second bracket 348 includes a lateral plate, shown as first plate 352, a first longitudinal plate, shown as second plate 356, and a second longitudinal plate, shown as third plate 360, and an extension portion, shown as stop 364. The first plate 352 is substantially parallel to the mower deck 80 and is coupled to the mower deck 80. The first plate 352 includes one or more apertures 368 configured to receive fasteners to couple the first plate 352 to the mower deck 80. The second plate 356 and the third plate 360 each extend from the first plate 352 and are substantially perpendicular to the first plate 352. The second plate 356 is substantially parallel to and spaced from the third plate 360. The second plate 356 defines one or more apertures 376 and the third plate 360 defines one or more apertures 380 configured to receive pins or fasteners. The second plate 356 and the third plate 360 each extend from a first end of the first plate 352 towards a second end of the first plate 352, the first end opposite the second end. The stop 364 extends between the second plate 356 and the third plate 360 and is spaced from the first plate 352. The stop 364 is configured to contact a portion of the yoke assembly 304 and limit rotation of the yoke assembly 304 in the first rotational direction (e.g., toward the mower arm 300, etc.). The stop 364 prevents excessive rotation of the yoke assembly 304, which limits overlap issues (e.g., limits uncut grass, etc.). In some embodiments, the stop 364 extends between the second plate 356, the third plate 360, and the first plate 352.

As shown in FIGS. 3-5, the mower deck 80 includes one or more second bracket fasteners 384. The second bracket fasteners 384 include one or more lateral plate fasteners 388 configured to be received within the apertures 368 of the first plate 352 to couple the first plate 352 to the mower deck 80. The second bracket fasteners 384 include one or more longitudinal plate pins 392, including a first pin 396 and a second pin 400. The first pin 396 and the second pin 400 extend between the second plate 356 and the third plate 360. The first pin 396 is configured to couple to a portion of the yoke assembly 304 and the second pin 400 is configured to contact a portion of the yoke assembly 304 and act as a stop to limit rotation of the yoke assembly 304 in the first rotational direction (e.g., away from the mower arm 300, etc.). The second pin 400 prevents the yoke assembly 304 from rotating too far, which limits overlap issues (e.g., limits uncut grass, etc.). The second pin 400 is located further from the mower arm 300 than the first pin 396. The first pin 396 coincides with the first axis 404 and provides the first rotation about the first axis 404 (e.g., the first rotation is provided about the first pin 396).

As shown in FIGS. 3-5, the yoke assembly 304 includes a yoke 412. The yoke 412 includes a first end plate 418 and a second end plate 422. The first end plate 418 is received within the first bracket 312 and the second end plate 422 is received within the second bracket 348. The first end plate 418 defines a first aperture 428 and a second aperture 430. The first aperture 428 receives the first pin 345 and couples the first end plate 418 to the second plate 320 and the third plate 324. The second aperture 430 coincides with a plate axis 406. The second end plate 422 defines a first aperture 432 and a second aperture 434. The first aperture 432 receives the first pin 396 and couples the second end plate 422 to the second plate 356 and the third plate 360. The second aperture 434 extends along the plate axis 406. The first end plate 418 and the second end plate 422 rotate about the first axis 404 (e.g., provide the first rotation about the first axis 404). Each of the first end plate 418 and the second end plate 422 extend away from the mower deck 80.

As shown in FIGS. 3-5, the yoke 412 includes one or more rods, shown as one or more bars 424, and the yoke assembly 304 includes a joint, shown as ball joint 456. The ball joint 456 is configured to provide a second rotation about a second axis 504. The second axis 504 is substantially perpendicular to the first axis 404. The ball joint 456 defines one or more aperture 460 configured to receive at least a portion of the one or more bars 424. The one or more bars 424 extends between the first end plate 418 and the second end plate 422 and are received by the ball joint 456. The one or more bars 424 includes a first bar 436 and a second bar 440. A first end of the first bar 436 is received within the second aperture 430 of the first end plate 418 and a second end of the second bar 440 is received within and extends through the ball joint 456, the first end opposite the second end. A first end of the second bar 440 is received within the second aperture 434 of the second end plate 422 and a second end of the second bar 440 opposite the first end is received within and extends through the ball joint 456. The first bar 436 extends away from the ball joint 456 at a first angle relative to horizontal and the second bar 440 extends away from the ball joint 456 at a second angle relative to horizontal. In some embodiments, the first bar 436 and the second bar 440 form a single, unitary bar. In some embodiments, the first bar 436 and the second bar 440 are integrally formed with or fixedly coupled (e.g., welded) to the first end plate 418 and the second end plate 422.

As shown in FIGS. 3-5, the yoke assembly 304 includes a housing, shown as ball joint housing 464, one or more bearings, shown as bushings 503, and a shaft 484 extending from the ball joint housing 464. The ball joint housing 464 is configured to receive the ball joint 456 and includes a first portion 468 and a second portion 472. The ball joint housing 464 is positioned along the one or more bars 424. The first portion 468 extends around the ball joint 456 and defines an aperture 476 configured to receive the ball joint 456. The second portion 472 includes a flange 480. The flange 480 extends from the first portion 468 away from the one or more bars 424, and the shaft 484 extends from the flange 480 away from the one or more bars 424. The shaft 484 is pivotably coupled to the mower arm 300. The shaft 484 defines an aperture 488 configured to receive a fastener 502. The one or more bushings 503 are disposed along a portion of the shaft 484, and the fastener 502 prevents the one or more bushings 503 from leaving the shaft 484 and secures the yoke assembly 304 to the mower arm 300. The one or more bushings 503 are configured to permit rotation about a third axis 505 to provide a third rotation. The third axis 505 is substantially perpendicular to and offset from the first axis 404 and the second axis 504 is substantially perpendicular to the third axis 505. The ability of the yoke assembly 304 to provide the first, second, and third rotations permits the vehicle 10 to tilt in a multitude of directions, permitting the vehicle 10 to traverse and cut slopes (e.g., hills, etc.).

As shown in FIGS. 3-5, the yoke assembly 304 includes an attachment piece 532. The attachment piece 532 includes a cylinder, shown as tube 536, a bracket, shown as plate assembly 540, and a stop, shown as retainer 542. The tube 536 extends around the shaft 484 and the one or more bushings 503. The plate assembly 540 includes a first plate 544 and a second plate 548. The first plate 544 and the second plate 548 are coupled to the mower arm 300. The first plate 544 couples to and extends from the tube 536. The mower arm 300 is configured to be lifted by the deck actuators 88 (as shown in FIG. 1A) and therefore the yoke assembly 304 is also lifted therewith. The retainer 542 is coupled to an end of the shaft 484 on a first side of the ball joint 456. The retainer 542 is configured to align with the aperture 488 and receive the fastener 502. The retainer 542 is configured to prevent the one or more bushings 503 from falling off the shaft 484 and prevent disengagement of the shaft 484 from the tube 536.

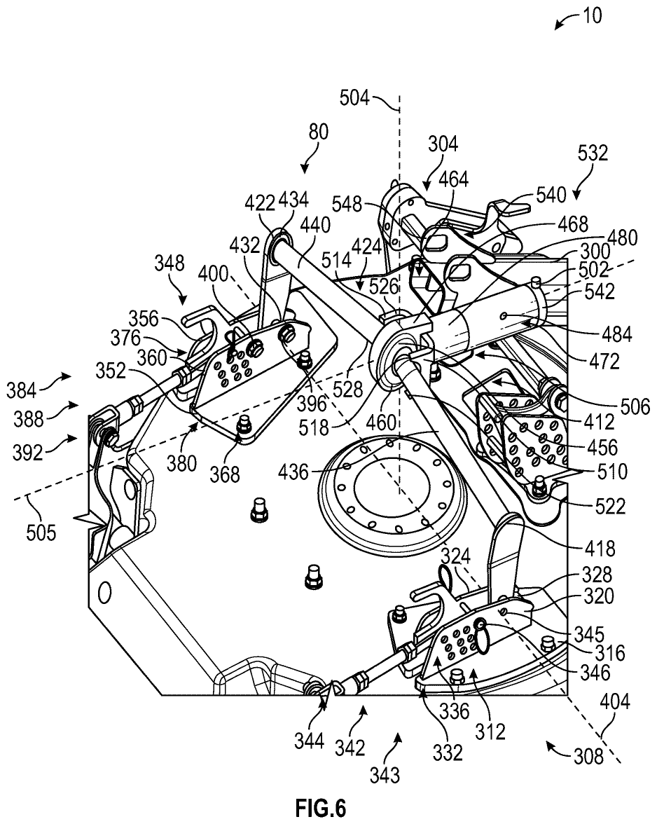

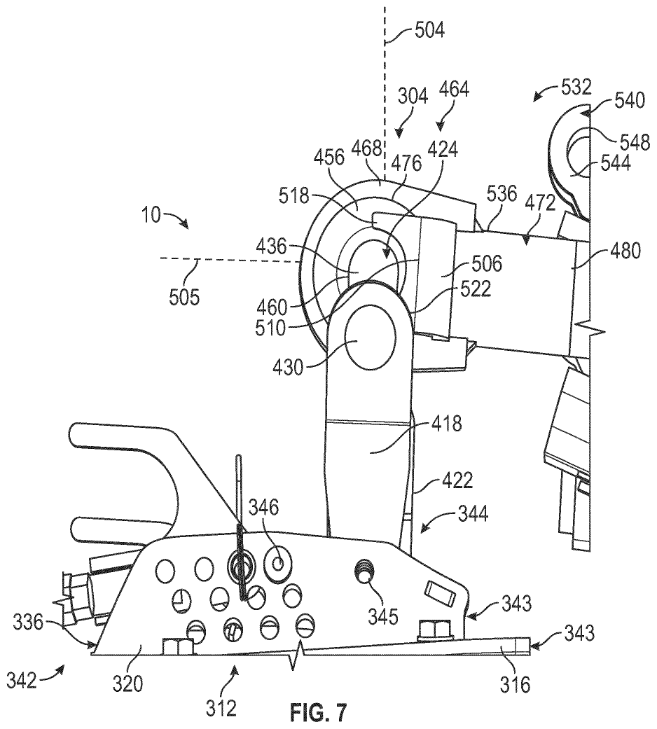

As shown in FIGS. 6 and 7, the yoke assembly 304 includes a stop 506 configured to contact the one or more bars 424 to limit at least one of the first rotation, the second rotation, or the third rotation. The stop 506 includes a stop first portion 510 and a stop second portion 514. The stop first portion 510 and the stop second portion 514 extend from opposing lateral sides of at least one of the ball joint housing 464 or the shaft 484 toward the one or more bars 424. The stop first portion 510 includes a first prong 518 and a second prong 522. The second prong 522 is closer to the mower deck 80 than the first prong 518 such that the stop first portion 510 straddles the one or more bars 424 with the first prong 518 positioned above the one or more bars 424 and the second prong 522 positioned below the one or more bars 424. The stop second portion 514 includes a first prong 526 and a second prong 528. The first prong 526 is located further from the mower deck 80 than the second prong 528 such that the stop second portion 514 straddles the one or more bars 424 with the first prong 526 positioned above the one or more bars 424 and the second prong 528 positioned below the one or more bars 424. The stop 506 prevents excessive rotation of the yoke assembly 304, which limits overlap issues (e.g., limits uncut grass, etc.).

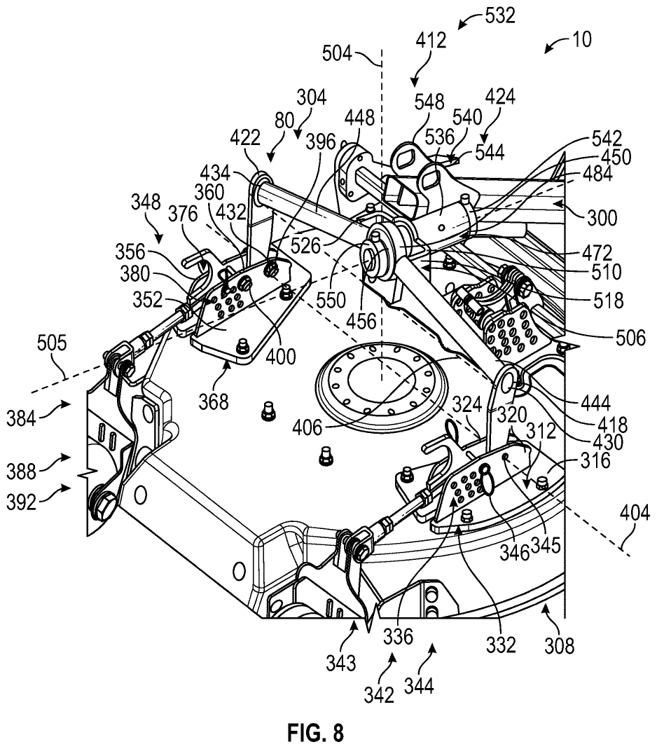

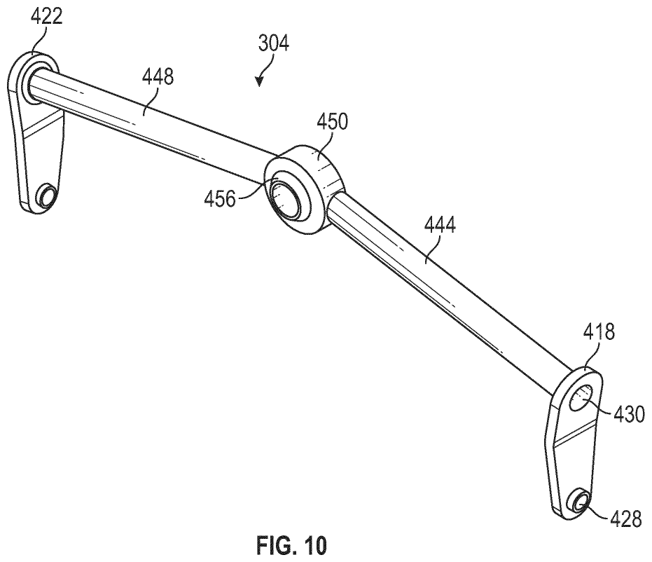

Referring now to FIGS. 8 and 10, an alternative embodiment of the yoke assembly 304 is shown. The yoke assembly 304 may be similar to the yoke assembly 304 of FIGS. 3-7, except as otherwise described herein. As shown in FIG. 8, the one or more bars 424 includes a first bar portion 444, a second bar portion 448, and a ball joint housing 450, positioned between the first bar portion 444 and the second bar portion 448. A first end of the first bar portion 444 is received within the second aperture 430 of the first end plate 418, and the first bar portion 444 extends to the ball joint housing 450. A first end of the second bar portion 448 is received within the second aperture 434 of the second end plate 422, and the second bar portion 448 extends to the ball joint housing 450. The first bar portion 444 extends away from the ball joint housing 450 at a first angle relative to horizontal and the second bar portion 448 extends away from the ball joint housing 450 at a second angle relative to horizontal. The ball joint 456 is disposed within the ball joint housing 450, and the shaft 484 extends through the ball joint 456 and the ball joint housing 450. In some embodiments, the ball joint housing 450 forms a substantially circular perimeter (e.g., as shown in FIG. 10). In some embodiments, the ball joint housing 450 forms an alternate perimeter (e.g., a rectangle with a circular aperture, etc.). The yoke assembly 304 includes a retainer 550. The retainer 550 is coupled to a free end of the shaft 484 and prevents the shaft 484 from decoupling from the ball joint housing 450 and the ball joint 456. The retainer 550 is coupled to an end of the shaft 484 on a first side of the ball joint housing 450 and the one or more bushings 503 are positioned along the shaft 484 on an opposing second side of the ball joint housing 450. The yoke assembly 304 of FIG. 8 may be desirable due to the ability to remove the retainer 550 from the yoke assembly 304, and then the yoke 412 from the yoke assembly 304, increasing ease of assembly, maintenance, and repair.

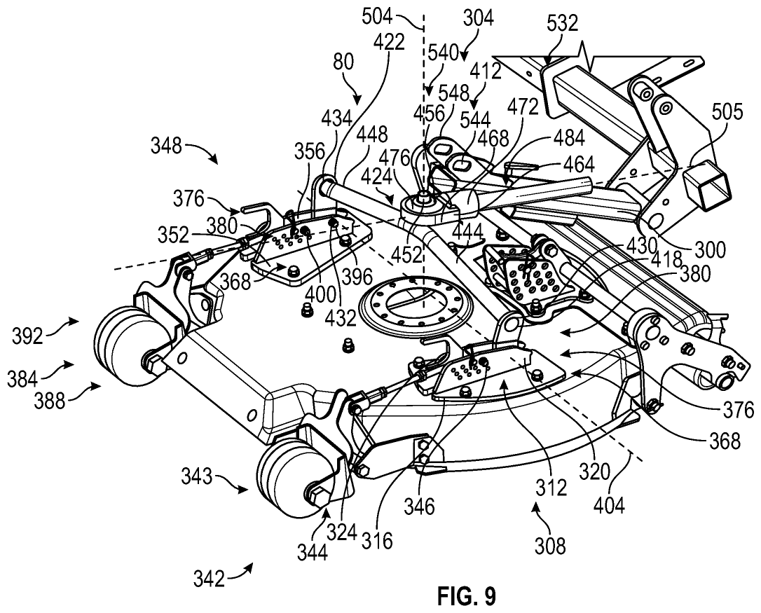

Referring now to FIG. 9, an alternative embodiment of the yoke assembly 304 is shown. The yoke assembly 304 may be similar to the yoke assembly 304 of FIGS. 3-8, except as otherwise described herein. The one or more bars 424 includes the first bar portion 444, the second bar portion 448, and a protrusion 452. The protrusion 452 extends substantially perpendicular from the first bar portion 444 and the second bar portion 448 and away from the mower deck 80, through the ball joint 456 and the first portion 468 of the ball joint housing 464. In such arrangement, the ball joint housing 464 is rotated ninety degrees relative to the ball joint housing 464 in FIGS. 3-7. Further, the yoke assembly 304 of FIG. 9 may include a retainer (e.g., similar to the retainer 550) positioned at a free end of the protrusion 452 to secure the yoke 412 in place relative to the ball joint 456 and the ball joint housing 464. The yoke assembly 304 of FIG. 9 may be desirable due to the ability to drop the yoke 412 from the yoke assembly 304, increasing ease of assembly and repair.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A mower comprising:
a chassis;
a tractive element coupled to the chassis;
a deck arm coupled to the chassis;
a mower deck;
a yoke assembly coupled between the mower deck and the deck arm, the yoke assembly configured to provide:
a first rotation about a first axis;
a second rotation about a second axis; and
a third rotation about a third axis.

2. The mower of claim 1, wherein the first axis is perpendicular to the second axis, the second axis is perpendicular to the third axis, and the third axis is perpendicular to the first axis.

3. The mower of claim 1, wherein:
the mower includes:
a first bracket coupled to the mower deck; and
a second bracket coupled to the mower deck;
the yoke assembly includes:
a yoke including:
a first plate received within the first bracket; and
a second plate received within the second bracket;
a first pin coupled to the first plate and the first bracket; and
a second pin coupled to the second plate and the second bracket; and
the first rotation is provided about the first pin and the second pin.

4. The mower of claim 3, wherein:
the first bracket includes:
a first bracket plate;
a second bracket plate; and
one or more stops extending between the first bracket plate and the second bracket plate, the one or more stops configured to limit the first rotation.

5. The mower of claim 3, wherein the yoke assembly includes a ball joint, and wherein the yoke includes a bar coupled to the ball joint and extending between the first plate and the second plate.

6. The mower of claim 5, wherein a portion of the bar is received within and extends through the ball joint.

7. The mower of claim 6, wherein the yoke assembly includes:
a housing configured to receive the ball joint;
a shaft extending from the housing; and
a stop extending from at least one of the housing or the shaft, the stop configured to contact the bar to limit at least one of the first rotation, the second rotation, or the third rotation.

8. The mower of claim 7, wherein the yoke assembly includes one or more bushings disposed along a portion of the shaft, the third rotation provided about the one or more bushings.

9. The mower of claim 8, further comprising:
an arm attachment piece including:
a tube extending along the shaft and around the one or more bushings; and
a bracket coupled to and extending from the tube, the bracket coupled to the deck arm.

10. The mower of claim 5, wherein the bar has:
a first bar portion extending away from the ball joint at a first angle relative to horizontal; and
a second bar portion extending away from the ball joint at a second angle relative to horizontal.

11. The mower of claim 5, wherein the yoke includes a housing positioned along the bar, the ball joint received within the housing.

12. The mower of claim 11, wherein the yoke assembly includes:
a shaft extending through the ball joint;
a retainer coupled to an end of the shaft on a first side of the ball joint; and
one or more bushings positioned along the shaft on an opposing second side of the ball joint.

13. The mower of claim 12, further comprising:
an arm attachment piece including:
a tube extending along the shaft and around the one or more bushings; and
a bracket coupled to and extending from the tube, the bracket coupled to the deck arm.

14. The mower of claim 13, further comprising a stop disposed around the tube, the stop configured to contact the bar to limit at least one of the first rotation, the second rotation, or the third rotation:

15. The mower of claim 5, wherein the bar includes a protrusion extending therefrom, the protrusions received by the ball joint, and wherein the yoke assembly include a retainer coupled to a free end of the protrusion.

16. The mower of claim 15, wherein the yoke assembly includes:
a housing configured to receive the ball joint; and
a shaft extending from the housing, the shaft pivotably coupled to the deck arm.

17. A mower assembly comprising:
a mower deck;
a deck arm configured to couple to a chassis;
a first bracket coupled to the mower deck;
a second bracket coupled to the mower deck; and
a yoke assembly coupled to the mower deck, the yoke assembly including:
a yoke comprising;
a first plate pivotably coupled to the first bracket;
a second plate pivotably coupled to the second bracket; and
a bar extending between the first plate and the second plate;
a ball joint coupled to the bar; and
a shaft pivotably coupled to the deck arm and coupled to the ball joint.

18. The mower assembly of claim 17, wherein the yoke assembly includes a housing coupled to the shaft, wherein the ball joint is disposed within the housing, and wherein a portion of the bar extends through the ball joint.

19. The mower assembly of claim 17, wherein the yoke includes a housing coupled to the bar, wherein the ball joint is disposed within the housing, and wherein the shaft extends through the ball joint.

20. A mower assembly comprising:
a mower deck;
a first bracket coupled to the mower deck;
a second bracket coupled to the mower deck; and
a yoke assembly coupled to the mower deck, the yoke assembly comprising:
a yoke including:
a first plate pivotably coupled to the first bracket;
a second plate pivotably coupled to the second bracket; and
a bar extending between the first plate and the second plate;
a ball joint coupled to the bar; and
a housing within which the ball joint is received;
a shaft extending from the housing, the shaft configured to couple to a deck arm of a mower;
a bushing disposed along the shaft; and
a stop positioned to engage with the bar to at least partially limit movement of the mower deck relative to the deck arm.
